(19) United States
(12) Patent Application Publication
(10) Pub. No.: US 2012/0091144 A1
(43) Pub. Date: Apr. 19, 2012

(54) FLEXIBLE CRYOSTAT

(76) Inventors: Rolf Gerald Baumgartner, Superior, CO (US); Ryan Andrew Sievers, Lyons, CO (US)

(21) Appl. No.: 13/041,841

(22) Filed: Mar. 7, 2011

Related U.S. Application Data
(60) Provisional application No. 61/311,628, filed on Mar. 8, 2010.

(51) Int. Cl. F17C 13/00; B29B 13/08

(52) U.S. Cl. 220/560.04; 216/94

(57) ABSTRACT

Provided is a flexible cryostat for use in applications including surrounding high temperature superconductor cabling. The flexible cryostat disclosed here in an embodiment includes a polymer pipe as the outer surface of the cryostat. In an embodiment, both the inner and outer pipes of a cryostat are replaced with polymer pipes which have the same or different thickness and composition. One or both of the polymer pipes can be used in combination with a permeation barrier, which is, in separate embodiments, ethylene vinyl alcohol, or a metallic layer such as aluminum or stainless steel. The flexible polymer pipe can surround the permeation barrier, or the permeation barrier can be positioned at the inner or outer surface of one or both flexible polymer pipes.

### CROSS-REFERENCE TO RELATED APPLICATIONS

This application claims priority to U.S. provisional application Ser. No. 61/311,628 filed Mar. 8, 2010, which is incorporated herein by reference.

### BACKGROUND OF THE INVENTION

High temperature superconductors (HTS) were discovered during the 1980s in layered, Pervoskite ceramic materials. Advances in material processing since then have demonstrated current capabilities in excess of copper by a factor of roughly 100 at liquid nitrogen temperature (LN2). In analogous fashion to low temperature superconducting (LTS) materials, HTS cables have been developed to supply high currents for electrical motors and electrical transmission. These efforts have been driven by greatly increased system efficiency for DC current transmission with significant energy savings. The optimization of HTS materials in cables for DC current transmission is now relatively mature and a number of projects have demonstrated high power transmission in HTS cabling over lengths up to 500 m. The cryogenic cooling for these demonstrations have been developed using standard cryogenic materials and practices well suited for the laboratory, but often difficult and costly to scale up for an industrial application.

To enable the superconducting state of the HTS conductor, the cable temperature must be maintained at approximately 70 K. This is accomplished by surrounding the HTS cable by liquid nitrogen within the inner pipe of an insulating cryostat designed to minimize heat leak. The cryostat must also be flexible so that it can be pulled through underground ducting. The existing current system is a vacuum insulated flexible cryostat consisting of two concentric stainless steel corrugated pipes. The inner cylinder contains the HTS cable and liquid nitrogen two-phase flow; the outer cylinder contains a vacuum and a thermal insulation/spacer material such as reflecting multilayer (MLI) or aerogels.

A typical HTS cable assembly in operation today is shown in FIGS. 1A and 1B. The cable includes an inner LN2 supply and HTS conductor assembly optimized for either AC or DC currents. The flexible outer cryostat shown in FIG. 1A uses two concentric stainless steel corrugated cylinders. The inner cylinder contains the LN2 two-phase return flow; the outer cylinder contains a vacuum with an aluminized multilayer insulation (MLI) system.

Reliability issues associated with existing cryostats using stainless steel corrugated cylinders or pipes are the primary obstacle to widespread adoption of HTS cables, and can be summarized as provided here. (1) Loss of vacuum integrity during or just after manufacture—micro cracks can develop in the corrugated metallic tubes due to excessive gaseous hydrogen gas content resulting in hydrogen embrittlement and the loss of vacuum. (2) Damage to cryostat during installation. Cryogenic hardware (e.g., pump-out ports and burst disks) can be damaged during the pulling of the cable in the cryostat that generates small leaks. This damage can be minimized with handling care and by recessing hardware in the cryostat ducts. (3) Loss of vacuum integrity during long-term service due to corrosion of the exposed metal lines. Getters are used for passive pumping to reliably address out-gassing. (4) Degradation in service due to voltage gradients between inner and outer tubes as a result of lightning strikes. These reliability issues drive excessive life-cycle costs that must be reduced to realize the potential economic benefits of adopting superconducting power cables. Overall reliability must be improved to be consistent with the utility perspective of “bury and forget” the cable/cryostat for 10-20 years. The initial cryostat cost combined with the vacuum pumping and maintenance cost of the cryostat system is approximately the same as the electrical cable cost. The life-cycle cost of the cryostat system from its initial procurement to recurring maintenance must be significantly reduced to become a cost competitive product for the utility industry. Currently, cryostat costs are estimated to be $800-$1,200 per meter. Design requirements must address the cost of cryostat materials, insulation, and vacuum operation.

### BRIEF SUMMARY OF THE INVENTION

Provided is a flexible cryostat for use in applications including surrounding high temperature superconductor cabling. The flexible cryostat described here includes a polymer pipe as the outer pipe of the cryostat, in an embodiment. In an embodiment, both the inner and outer pipes of a cryostat are replaced with polymer pipes which have the same or different thickness and composition. One or both of the polymer pipes can be used in combination with a permeation barrier, which is, in separate embodiments, ethylene vinyl alcohol, a fiberglass overwrap, or a metallic layer such as aluminum or stainless steel. The flexible polymer pipe can surround the permeation barrier, or the permeation barrier can be positioned at the inner or outer surface, or within the wall of one or both flexible polymer pipes. If more than one polymer pipes are used, the composition of each pipe may be the same or different. If more than one permeation barrier is used, the composition of each permeation barrier may be the same or different.

The flexible cryostat described here may be described as an advanced hybrid cryostat. The flexible cryostat described here uses polyethylene (PE) materials that are widely used commercially for underground storage tanks and piping. There is a current emphasis in replacing metal by polyethylene in industrial piping, however, the use of plastics for cryogen containment has not been demonstrated even though plastic materials have been used in cryogenics since the 1950s. The limiting factors for more widespread use are the development of appropriate plastics with the inherent structural capabilities of metals, manufacturability, and cost. Special polyethylenes are now available that have been toughened to survive normal environmental weathering for 100 years or more (for example, the PE100 material specification implies a 100-year lifetime). These materials and others that are known in the art are useful in the current invention.

Described here is a new material and system that can reduce the initial procurement and recurring maintenance costs and to improve on cryostat reliability issues. The already developed HTS power cable in a cryostat system developed for industrial application using known cryogenic standards can be used, but with high or medium density polyethylene (H(M)DPE)) materials in the cryostat, for example.

More specifically, in an embodiment, polyethylene (PE) is used for the outer flexible cryostat vacuum jacket rather than corrugated stainless steel in an embodiment. This provides net system benefits detailed below and elsewhere herein. The inner pipe can utilize corrugated stainless steel as currently used in HTS cryostats or a PE pipe as described here. The resulting hybrid design provides a reduced risk approach for incorporating low-cost PE into a HTS cable cryostat system; an example of an embodiment of the concept is shown in FIG. 2. This hybrid cryostat approach eliminates or reduces key problems associated with vacuum integrity, degradation in service due to lighting strikes and corrosion, and life cycle cost, for example.

More specifically, provided is a cryostat comprising: an inner pipe and an outer pipe, wherein the inner pipe is oriented inside the outer pipe in a generally concentric arrangement; an annular region between said pipes for supporting vacuum conditions; wherein the outer pipe comprises a polyethylene and a permeation barrier. In an embodiment, the inner pipe also comprises a polyethylene form. In an embodiment, the polyethylene is selected from the group consisting of: high density polyethylene, medium density polyethylene, low density polyethylene and crosslinked polyethylene (PEX). Any of a variety of molecular weight ranges of PE can be used in separate embodiments. In an embodiment, the inner pipe is a polyethylene (PE) pipe and further comprises a permeation barrier. In an embodiment the inner pipe is a metal pipe and the outer pipe is a polyethylene pipe and a permeation barrier. In an embodiment, both the inner and outer pipes are polyethylene.

The inner and outer pipes of the cryostat are of any suitable size (diameter and thickness, for example) to function in the desired use, as will be apparent to one of ordinary skill in the art without undue experimentation. In an embodiment, the inner diameter of the cryostat is (ID) is about 164 mm and outer diameter about 200 mm. This creates the necessary annulus space required to accommodate a suitable level of MLI insulation. In this embodiment, the annular gap between the inner and outer pipes is 25.5 mm to accommodate the MLI and the spacers needed to achieve a heat leak of no greater than 1.5 W/m. As is readily apparent to one of ordinary skill in the art, there are other sizes of pipes that can be used. For example, in an embodiment, the inner diameter can be between about 75-100 mm and the outer diameter can be between about 100-150 mm for example. The ID is dependent on the superconducting cable geometry. This drives a minimum inner diameter requirement for the corrugated inner pipe, as known in the art. The desired vacuum level and/or heat leak, among other factors known in the art drive the outer pipe diameter.

The inner and outer pipes of the cryostat may be the same thickness or the thicknesses may be different. The inner and outer pipes of the cryostat are arranged in a generally concentric arrangement. This means that the inner pipe is oriented inside the outer pipe and the pipes are spaced apart. It is known in the art that the insulation value of a cryostat is diminished if the pipes are touching and if the annular space varies in size, although this may happen during use. These aspects are included in the invention and do not prevent a generally concentric arrangement from being present.

As an example, exemplary system parameters are provided in Table 1.

TABLE 1
Exemplary system parameters.

| CRYOSTAT SYSTEM | EXEMPLARY |
|---|---|
| PARAMETER | REQUIREMENT |
| Cryostat diameter | Inner: 75 to 165 mm |
| | Outer: 125 to 200 mm |
| Allowable heat leak | <1 W/m |
| Design pressure | Inner pipe: 20 bars |
| | Outer pipe: 5 bars |
| Cable minimum bend radius (HTS size | 1.5-3.0 m |
| dependent) | |
| Maximum cable pulling force | 800 kg |
| Sidewall bearing pressure limit | 200 kg/m |
| Spacers between HTS and inner line | None |
| Power type (AC/DC) | AC or DC |
| Instrumentation & interfaces | Active vacuum monitoring + |
| | burst disc & pumpout port |
| Safety relief | Yes |
| Cryostat length | 100-500 m |
| Life expectancy | 30 years |
| Number of thermal cycles | <10 |
| Cryostat assembly cost | <$200/m |
| Environment | Underwater & underground in |
| | duct bank |

The inner and outer pipes of the cryostat have an annular region between. This is generally a spacing of the inner and outer pipe. The annular space can be any suitable distance between the pipes, and is useful to accommodate MLI or other insulation material as required, or desired to meet system requirements, as known in the art.

In one embodiment of the use of one aspect of the disclosure herein, a vacuum is present in the annular space. The vacuum is designed to aid in the insulation value of the cryostat, and may be any suitable pressure that allows the function of the cryostat as described or desired. In an embodiment, the pressure in the annular space is less than or equal to 1×10⁻³ Torr. In an embodiment, the pressure in the annular space is less than or equal to 1×10⁻⁵ Torr. In an embodiment, the pressure in the annular space is less than or equal to 4×10⁴ Torr when MLI insulation is used. Other vacuum levels are included, as is known in the art. As is known in the art of cryostats, the vacuum is sometimes reduced due to physical problems or other issues. The cryostat described here is intended to include such reductions in the vacuum level.

The permeation barrier is used to reduce the vacuum decay due to permeability. As is apparent to one of ordinary skill in the art, the permeation barrier can be made from any material which is sufficiently nonpermeable to air constituent molecules or the atmosphere inside or outside the cryostat. In an embodiment, the permeation barrier is ethylene vinyl alcohol (EVOH). In an embodiment, the permeation barrier is a metal. In separate embodiments of the aspect of the invention where the permeation barrier is metal, the metal is selected from the group consisting of: aluminum and stainless steel and alloys thereof. In an embodiment, the permeation barrier is a fiberglass-epoxy composite overwrap. In an embodiment, the fiberglass-epoxy composite overwrap is Fiberspar LinePipe. This commercially available pipe contains an inner thermoplastic pressure barrier that is reinforced by high-strength glass fibers embedded in an epoxy matrix. This pipe is also available with HDPE or cross-linked polyethylene (PEX) pressure barriers with temperature ratings to 140° F. and 180° F., respectively. The size of the pipe currently available in an embodiment ranges from ID 51 mm-142 mm and OD 63 mm-175 mm. Min, bend radius ranges from 145 cm-425 cm with a reinforced wall thickness range from 1.2 mm-7.2.

Metallic barrier layers provide the greatest permeation resistance, and commercially available pipes with an aluminum layer sandwiched between ID and OD PE layers are available. Also, combinations of metal layers and EVOH coatings can be used to provide the desired permeation resistance. These materials and their use are known in the art.

Non-metallic barrier layers can also provide significant permeation resistance and are included in the disclosure herein, but typically non-metallic barrier layers provide permeation resistance to a lesser degree than metallic barriers. An advantage of the non-metallic barrier materials is that the flexibility of the pipe is not adversely affected, as it is with metallic barriers.

In an embodiment, the permeation barrier is adjacent to the inner surface of the outer pipe of the cryostat. In an embodiment, the permeation barrier is adjacent to the outer surface of the inner pipe of the cryostat. In an embodiment, the permeation barrier is adjacent to the outer surface of the outer pipe of the cryostat. In an embodiment, the permeation barrier is integrated within the wall of the pipe. The permeability performance of PE shows a strong dependence on the density of the PE, as is known in the art. Therefore, both the PE density and permeation barrier material/configuration affect the performance coefficients and can be used to tailor the pipe to the desired performance. These adjustments are known in the art.

In an embodiment, the EVOH permeation barrier is integrated into the PE pipe using a coextrusion coating process, as known in the art.

Also provided are methods of using the cryostat described here in an existing cryostat installation, for example. Provided is a method of joining two sections of cryostat together, where each cryostat section comprises an inner stainless steel pipe and an outer polyethylene pipe, with an annular space therebetween, the method comprising: Welding the inner stainless steel pipe joints together; Adding an optional insulation material in the annular space; Joining outer polyethylene pipes together.

Also provided is a method of joining two sections of cryostat together where the first cryostat section comprises an inner stainless steel pipe and an outer stainless steel pipe with an annular space there between and the second cryostat section comprises an inner stainless steel pipe and an outer polyethylene pipe, the method comprising: Joining the inner stainless steel pipe of the first cryostat section with the inner stainless steel pipe of the second cryostat section by welding; Joining the outer stainless steel pipe of the first cryostat section with the outer polyethylene pipe of the second cryostat section by preparing the polyethylene surface and bonding the pipes together.

In an embodiment, the cryostat described here can be prepared so that when bent, the bend radius allows for transportation over the road or rail.

Multilayer insulation (MLI) is used as an example insulation material for the PE-based cryostat. The use of MLI and other insulation materials is well understood and the internal geometry of the vacuum annulus will accommodate MLI in the same way as in current flexible metal cryostats. The same thermal performance (≦1 W/m) is expected so long as the required vacuum level is achieved and maintained during cold operation (≦4×10⁴ torr, for example).

### BRIEF DESCRIPTION OF THE DRAWINGS

FIG. 1A and FIG. 1B show a typical HTS cable assembly.

FIG. 2 shows a schematic of a hybrid flexible cryostat device.

FIG. 3A and FIG. 3B show an example of a field joint.

FIG. 4 shows results of Charpy impact strength test.

FIG. 5 shows results of thermal expansion test.

FIG. 6 shows results of simple lap-shear test in compression.

FIG. 7 shows results of lap-shear test.

FIG. 8 shows results of vacuum decay test showing (a) 15 hours, and (b) 40 minutes.

FIG. 9 shows barrier pipe samples, with close-up edge views illustrating respective barrier layers.

FIG. 10 shows an example of a field joint.

FIG. 11A shows an exemplary schematic of completed cryostat sections positioned for joining.

FIG. 11B shows a welded cryostat inner pipe.

FIG. 11C shows a cryostat outer pipe butt joint by thermal fusion.

FIG. 11D shows a cryostat coiled as sections are completed and joined.

FIG. 11E shows a cryostat vacuum pump down example.

FIG. 12 shows a drawing of two cryostat sections with connection joint.

FIG. 13 shows Individual cryostat section with cutaway detail.

FIG. 14 shows a hybrid HTS cable cryostat joint example.

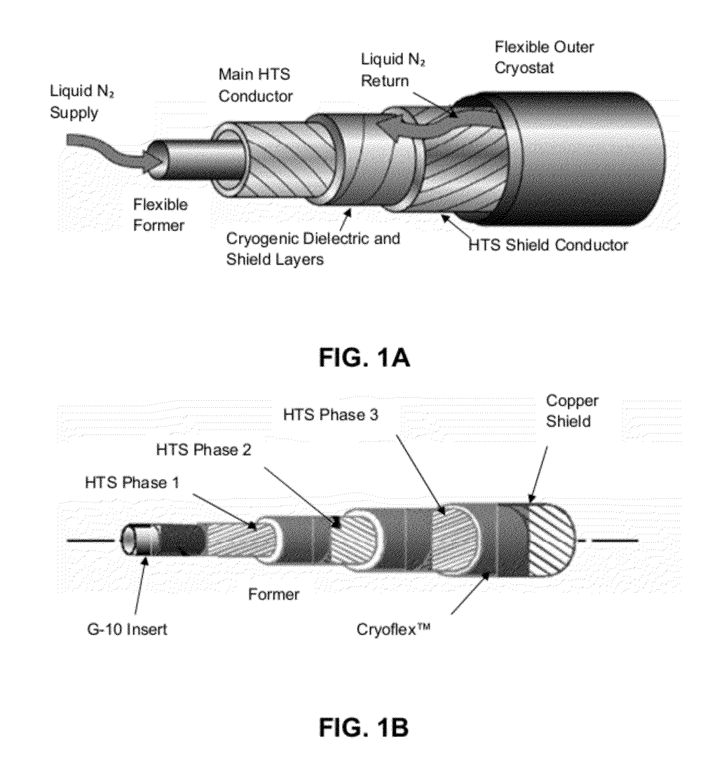

### DETAILED DESCRIPTION OF THE INVENTION

The following examples are used to more fully explain and illustrate embodiments of the invention. The examples are not intended to limit the scope of the invention.

Described here is the use of previously unused materials in cryostat applications for use in applications such as insulating high temperature superconducting power cables. These disclosed materials and methods have advantages such as improving cryostat reliability and reducing the life-cycle costs of the cryostat system. The materials used are a combination of flexible plastic materials, including polyethylene (PE) plastics, for the outer cylinder instead of corrugated stainless steel in a cryostat application. Benefits provided by this approach are increased vacuum integrity, resistance to lighting strikes and corrosion, and lower life cycle cost, for example.

A particular exemplary application is the use of the disclosed materials and methods with existing high temperature superconductor (HTS) cabling and system interfaces. The disclosed cryostat is interchangeable with existing cabling and interfaces. A second exemplary application is the use of transporting liquid cryogens from one place to another using the disclosed system as the piping system. These are not the only uses of the invention, and other uses will be easily appreciated by one of ordinary skill in the art. These other uses are intended to be included in the invention.

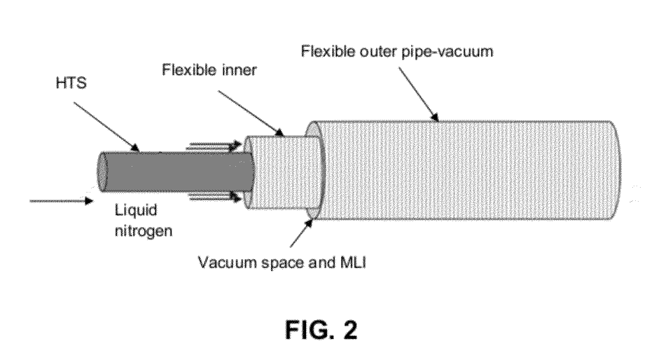

An embodiment of the PE cryostat design described here is shown in FIG. 2. FIG. 2 shows a polyethylene-based outer vacuum jacket.

Another aspect of the invention is a bonded transition from the outer pipe (for example polyethylene-based) to the stainless steel termination of an existing cabling application.

As an example, a cryostat system was made using a convoluted (corrugated) inner pipe based on a commercially available Penflex 700 Series part, 316L or 304 stainless steel, with an inner diameter of 3.5 in (89 mm). As is known in the art, any suitable size for the application desired, for example a size sufficient to accommodate an HTS cable, can be used. The convoluted pipe in this example includes a braid to provide an internal pressure capability of 20 bar. This increases the inner pipe outer diameter to 4.45 in (113 mm). The current baseline 200-mm outer polyethylene-based pipe (described further below) has inner and outer diameters of 164 and 200 mm, respectively. In this example, the annular gap between the inner and outer pipes is 25.5 mm to accommodate the MLI and the spacers needed to achieve a heat leak of no greater than 1.5 W/m.

### Outer Vacuum Jacket

The Polyethylene-based outer pipe provides a number of characteristics to enable adoption for cryostats, including the ability to maintain effective vacuum level, flexibility, and low cost. Flexibility and cost have been addressed through the use of inexpensive polymer materials that can be processed using efficient manufacturing/assembly methods. These polymers are also inherently flexible.

### Vacuum Capability

The three primary mechanisms by which molecules enter a vacuum annulus are: leaks, outgassing from components exposed to vacuum, and permeation of atmospheric gasses through the pipe wall. Leaks are controlled with an effective design and manufacturing process. Permeation is addressed with the flexible cryostat design described herein, as the gas load by permeation for typical polyethylene materials is too high to allow for an acceptable static vacuum level over many years. This effect must be dealt with at the material level, because manufacturing techniques and vacuum conditioning are generally thought to have no influence on it. Plastics and polymers in general are known to be permeable to gas molecules, with the rate of permeation dependent on the material, the gas species, temperature, and the moisture content of the material.

A model was generated to predict the vacuum decay due to permeability. The composition of air was used to calculate the partial pressures of the various constituent molecules in the air. The permeability coefficients were gathered for these molecules from a number of sources. Data were not typically available for specific polymer resins (e.g. Dow DGDA-2420), but rather for classes of polymers (e.g. polyethylene (PE), nylon, etc.), which adds some uncertainty to the modeling results. One notable discovery was that the permeability coefficients for PE varied significantly with density. Based on the permeability coefficients, the composition of air, and the pressure differential across the wall, the amount of gas permeating through the wall was calculated, leading to a vacuum decay rate estimate.

The first configuration evaluated using the model was the Dow DGDA-2420 resin vacuum test article. This analysis is described below.

### Material Testing

A detailed study of several factors including the design of joints between PE and PE, joints between PE and metal, and the capability of the PE pipe to withstand the pressure loads required was carried out. These factors are described next.

The first analysis performed was a preliminary stress analysis of the inner and outer pipes based on internal and external pressures and bending loads, using thick cylinder stress calculations. The results are shown in Table 2. The external pipe is required to withstand 5 bar of external pressure because the pipe may be buried in the ground. The internal pipe must withstand 20 bar of internal pressure from the LN2 flow. Ultimate strength values were not available for either of the resins tested, so the analysis focused on the published yield strengths of the materials. Because it appeared that either resin would be likely to produce acceptable factors of safety, the DGDA-2420YL resin was selected for further use because it has a lower modulus, which reduced the force required to bend the pipe, and because the high elongation-to-break characteristics suggest that low-temperature properties may be better than the DGDA-2490BK resin. After material property testing of the selected PE resin was complete, it was found that the measured ultimate strength of the PE at room temperature was only 3% greater than the published yield strength. This was unexpected, as polymers usually exhibit a much larger difference between yield and ultimate strengths. Because the ultimate strength was lower than anticipated, the factor of safety of 3.0 is lower than desired. ASME pressure vessel code requires a factor of safety of 3.5 for ultimate strength. Example ways to obtain the desired factor of safety is to use another resin, such as DGDA-2490BK, which has significantly higher strength and would provide acceptable factors of safety even using the most conservative assumption, that the ultimate strength is no greater than the published yield strength; or to use the fact that the low-temperature strength is seven times greater than the room-temperature strength. The inner pipe would only experience the 20 bar requirement when filled with LN2, at which time the material would exhibit much greater strength and have a very conservative factor of safety of 23.0. The only potential issue with this approach would be if during the process of filling the pipe with LN2 the pressure increased to 20 bar before the pipe had cooled enough to handle the load. The conditions during the fill process can be investigated and modified as necessary to meet the desired safety factors using the information described herein and known in the art.

Also considered was the minimum bend radius of the pipe. Stress calculations assumed a maximum allowable stress of ⅔ of yield (FOS=1.5) using simple beam theory. Results are also shown in Table 2.

TABLE 2
Calculated factors of safety from mechanical loading.

| | Outer Pipe | | Inner Pipe | |
|---|---|---|---|---|
| | DGDA- | DGDA- | DGDA- | DGDA- |
| | 2420YL | 2490BK | 2420YL | 2490BK |
| | Resin | Resin | Resin | Resin |
| Pipe OD | 6.625 | 6.625 | 4.5 | 4.5 |
| SDR | 13.5 | 13.5 | 7 | 7 |
| Internal Pressure | 0 | 0 | 20 bar | 20 bar |
| External Pressure | 5 bar | 5 bar | 0 | 0 |
| Factor of Safety | 4.9 | 6.8 | 2.9 | 4.0 |
| (yield strength) | | | | |
| Factor of Safety | 5.1 | NA^{a} | 3.0^{b} or 23.0^{c} | NAa |
| (ultimate strength) | | | | |
| Force to bend pipe | 27 kg | 37 kg | 13 kg | 18 kg |
| Radius of | 4.3 m | 5.3 m | 3.0 m | 3.6 m |
| curvature | | | | |
| (calculated) | | | | |
| Radius of | 4.2 m | 4.2 m | 2.3 m | 2.3 m |
| curvature | | | | |
| (published) | | | | |

^{a}Ultimate strength data not available
^{b}Assuming room-temperature ultimate strength (18.6 MPa)
^{c}Assuming low-temperature ultimate strength (142 MPa)

Insulation. Multilayer insulation (MLI) is used for the exemplary PE-based cryostat. This is because the use of MLI is well understood and the internal geometry of the vacuum annulus will accommodate MLI in the same way it is in current flexible metal cryostats. The same thermal performance (≦1 W/m) would be expected so long as the required vacuum level is achieved and maintained during cold operation 4×10⁻⁴ torr).

Polyethylene resin and pipe. PE has evolved dramatically in recent decades and many resin materials are now available that have the desired characteristics for this application. Resins currently used in PE pipe can be used, as well as other formulations, providing they possess the characteristics described herein. A variety of PE resins have been developed for use in gas and water pipes for 100-year service and can be used here. Some examples of useful materials include 1) Endot PE2708/2406 yellow gas pipe, 2) Endot Endopure blue water pipe, and 3) Endot PE4710 black gas pipe with three yellow stripes. The two resins are DGDA-2420YL for the PE2708/2406 pipe and DGDA-2490BK for the PE4710 pipe. The Endopure pipe also uses a DGDA-2490 resin. Both resins contain minimal additives and have acceptable strength for pressure loading. The DGDA-2420YL resin was selected for this example because it has superior elongation-to-break characteristics and lower modulus. Greater elongation-to-break performance is desirable because such a material is likely to stay more ductile at cryogenic temperatures and be less likely to develop microcracks during thermal cycling that could affect vacuum performance. The lower modulus is desirable to accommodate bending of the pipe for installation.

The material used was tested to determine its mechanical properties, particularly at low temperatures. Initial tests were performed to determine how the materials would behave at LN2 temperature, 77 K, and after repeated thermal cycles from 295 K to 77 K. A material sample was cut from a section of pipe and immersed in liquid nitrogen for 3-4 minutes. Afterward, the sample was removed and allowed to return to room temperature. This procedure was repeated 20 times. Before and after the thermal cycles, the specimen was examined with magnification to check for obvious degradation or cracks. No evidence of degradation or cracking was found after thermal cycling.

Additional testing was performed to determine:
Tensile strength at 295 K and 77 K
Thermal expansion from 295 K to 77 K
Charpy impact strength at 295 K and 77 K

Additionally, material tests were included to better understand the behavior of adhesive bonded joints with the PE material. Lap-shear testing was identified to determine the behavior of PE bonded joints both at 295 K and 77 K, and bonds of PE-to-PE and PE-to-metal both needed to be addressed.

Specimens for each test were cut from a finished section of PE pipe to examine the material in its most representative condition, and were designed to accommodate testing to ASTM standards. Some samples were also taken in multiple orientations relative to the pipe to determine how isotropic the material is after being extruded into a pipe form. Machining of the specimens (e.g., surface finish, flatness, cutter material, coolants used) was critical and a machinist experienced in this area was used for the work. Annealing the specimens to remove surface stresses due to machining was considered, but not performed.

Tensile test. The first test performed was a tensile strength test as known in the art. From this test, the ultimate strength and tensile modulus were determined at room temperature (295 K) and LN2 temperature (77 K). The results are shown in Table 3.

TABLE 3
Results of tensile tests.

| | Test | | | Elongation |
|---|---|---|---|---|
| Specimen | temp | Modulus | Strength | to Break |
| No. | (K) | (GPa) | (MPa) | (%) |
| 1 | 295 | 0.71 | 18.5 | >400 |
| 2 | 295 | 0.55 | 18.1 | >400 |
| 3 | 295 | 0.61 | 19.3 | >400 |
| Avg | 295 | 0.62 | 18.6 | >400 |
| 4 | 77 | 7.7 | 146.7 | 2.9 |
| 5 | 77 | 8.8 | 128.4 | 1.7 |
| 6 | 77 | 15.2* | 149.9 | 1.7 |
| Avg | 77 | 8.25 | 141.7 | 2.1 |

*Outlying data value.

It is noteworthy this polyethylene exhibits a high elongation to break of >400% (called no break) at room temperature and also enhanced toughness at low temperatures. It was surmised that the elongation to break could be as large as 10-20% at 77 K or reduced by a factor of 20-40 from room temperature; a typical reduction for Teflon and polyimide, to plastics commonly used in cryogenics. Whether the enhanced toughness at low temperature would also extend to cryogenic temperatures and increase the Charpy resistance to brittle failure was investigated.

The cryogenic lifetime of ductile materials undergoing tensile strain from cryogenic cycling can be estimated from a so called “rubber band” model. The number of cryogenic cycles N (room temperature to ˜100 K and back to room temperature) may be extrapolated using a formula derived from numerous reliability studies which is based on the net energy to break a material.

N=A(sb/st)p

where
sb=elongation to break %
st=tensile strain %
A=constant of order unity
P=a value from 2 to 3 typically.

A reliable cryogenic system has a ratio of sb/st of 5-10 such that N=100-1000. The elongation to break of the MDPE was ˜2% at 77 K which will limit the maximum tensile strain in the design during cooldown to 0.2%. If the elongation to break had been 20%, the high CTE of the polyethylene of 1.8% to 77 K would have been much less of an issue in the design and cooldown of a plastic inner line.

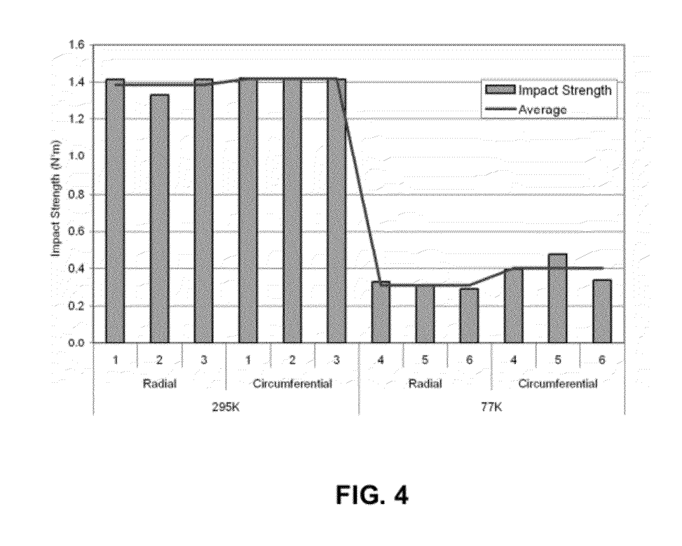

Charpy impact test. In order to determine the relative toughness of the material to resist cracking, Charpy impact tests were also performed at 295 K and 77 K. The results are shown in FIG. 4. There is little difference between the different sample orientations, supporting the notion that the material is at least quasi-isotropic and remains so after the extrusion process. Also, the impact strength at low temperatures is a factor of 3.5 to 4.5 lower than at room temperature.

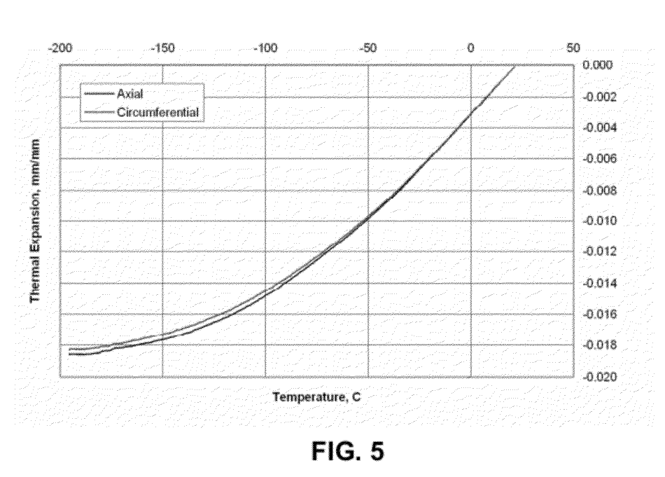

Thermal expansion test. Thermal expansion behavior was also measured for the material because it is critical for determining the shrinkage of a pipe when filled with LN2 and also the stresses at the joints between PE and other materials. The results are shown in FIG. 5. Again, the difference between the orientations of the samples is small, so the material is essentially isotropic after the extrusion process. The thermal expansion was −1.85% in the axial direction, which is in the expected range. For comparison, the thermal expansion of 304 stainless steel and 6061-T6 aluminum are −0.28% and −0.39%, respectively. Thermal expansion of polymers is well known to be greater than that of metals. For Nylon and Teflon the thermal expansions are −1.26% and −1.94%, respectively. Because the thermal expansion of the PE is so much greater than that of metals, more work will be required on the expansion joints in the system to accommodate the large deflection of a PE inner pipe.

Joint design. There are several critical elements to the design of a HTS cable cryostat using PE as the primary material. Joints are key areas of interest. Vacuum-tight joints must be made using joining techniques not used in traditional metal vacuum vessel construction. Additionally, the joints have to withstand thermal cycling and stress associated with thermal contraction, pressure loading, and cable bending. These factors led to further study of different methods of joining including adhesive bonding, thermal fusion, electrofusion, and hot-air welding.

Adhesive bonding to PE can be challenging because its low surface energy yields low bond strength. There are several solutions to this problem, but two examples are acid etching and plasma etching. Acid etching removes hydrogen from the surface, leaving dangling carbon bonds thus allowing the adhesive to chemically bond to the surface. It is highly effective, but the chemicals required, sulfuric acid and sodium dichromate, require special handling that will influence the cost of the finished product. Practically, the method of immersing the end of a long pipe in the acid solution is challenging as well. Plasma etching, on the other hand, has a similar chemical effect on the PE surface but is safe, clean, and simple to implement in a manufacturing environment. Adhesive bonding must be performed with minimal time delays following acid etching or plasma treatment, as neither surface treatment is permanent and will degrade over time. Acid etching was used in this example.

Thermal fusion and electrofusion are the most common industrial methods for joining PE pipe. These methods locally melt the pipe and allow it to flow together to form a joint with the strength and reliability of the original material. Thermal fusion is typically accomplished using simple butt joints. Each mating end is heated and then the two surfaces are pressed together, yielding a joint as strong as the pipe itself. Electrofusion is accomplished using a collar into which two pipe ends are inserted. The collars are produced with heating coils molded into the inner surface, so the joint is made by applying a controlled current profile to the collar, which locally melts the surface of the pipe and the collar causing the materials to flow together to form the joint. This joint is also at least as strong as the pipe itself.

Bonding process development. A study was conducted to determine an appropriate method of bonding to PE because the material typically yields lower strength bonds. Both plasma treatment and chromic acid etch techniques were tested here. All aluminum surfaces were acid etched before bonding.

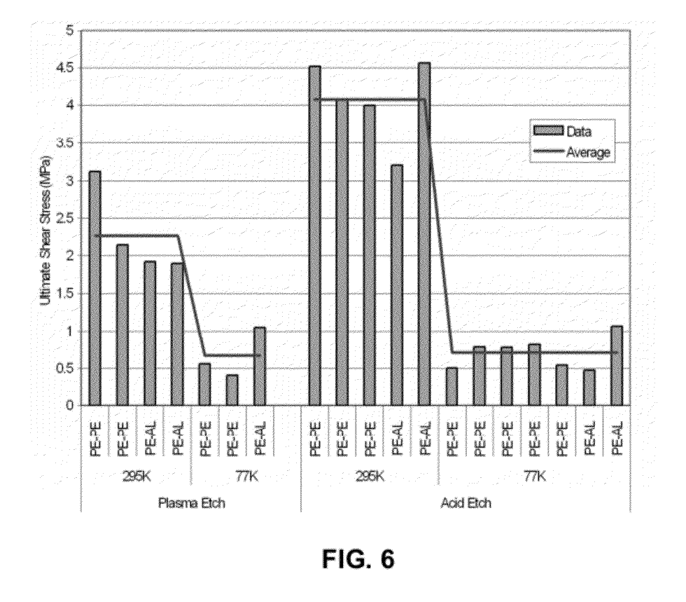

To determine the optimal bonding parameters and process for the lap-shear, simple rectangular specimens were produced for testing. PE-to-PE joints and PE-to-aluminum (AL) joints were tested at 295 K and 77 K. Aluminum 6061-T6 was selected to minimize the thermal contraction difference with PE. The shear loading was applied in compression rather than tension to accommodate our available equipment. Any differences between this test and the subsequent tensile lap-shear tests performed were evaluated with this consideration. A summary of the simple lap-shear tests in compression is shown in FIG. 6.

The plasma-etched samples demonstrated only 60% of the strength of acid-etched samples at room temperature. One factor of concern is the time between etching and bonding, which in the case of the plasma etch was roughly 24 hours. For all further work in this example, acid etching was used so that results would not be affected by sub-optimal conditions. Another result was that the PE-to-PE samples and PE-to-aluminum samples performed quite similarly. Because the samples failed either in the epoxy (cohesive failure) or at the PE interface, this result would be expected. Another result was that the low temperature bond strength was only 17% of the room temperature strength. This result was unexpected, possibly due to the fact that the test was performed in compression rather than tension, and bending of the sample introduced loads to induce peel in the bonds. Abrasion of the PE surfaces showed no improvement in bond strength, and different bond lengths showed no difference in strength. This suggests that peel was a significant factor in the reduced performance. This result was not unexpected when testing small samples. For the tensile lap-shear samples, these results led to using acid etching and no abrasion for surface preparation and a 19-mm bond length.

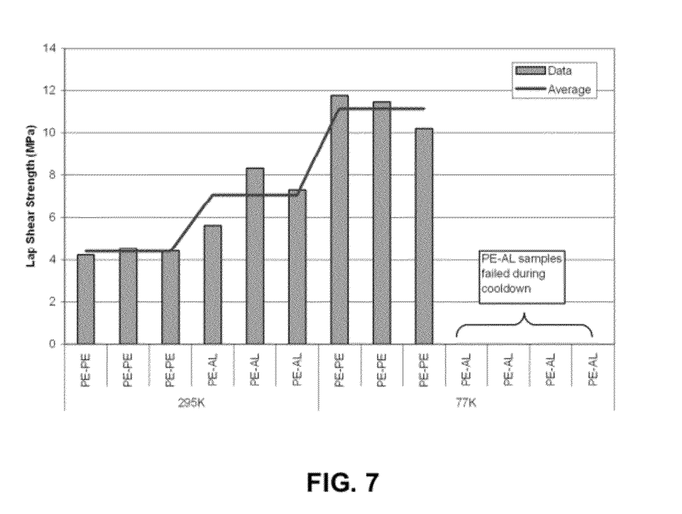

Lap-shear test. Lap-shear tests were performed in tension, at room and low temperatures and for PE-to-PE bonds and PE-to-aluminum bonds. The results of this testing are shown in FIG. 7. The bond strengths measured at room temperature for the PE-to-PE samples was very similar to that measured in the compression lap-shear test of 4.4 and 4.1 MPa respectively. The PE-to-aluminum bonds showed a 60% higher strength than the PE-to-PE bonds in this test, whereas the compression lap-shear test showed no noticeable difference. This is likely due to the bending of the samples experienced in the compression test, which generated peel loads on the bonds. Another notable result was that the 77 K results showed 2.5 times greater strength than the room temperature results. Based on other cryogenic material testing, this behavior is fairly typical.

The compression test showed significantly lower strength at low temperatures, which is not typical and again likely due to the peel loads on the samples. Overall, the lap shear results were promising and demonstrated that high strength epoxy bonds can be made to the PE, which has historically shown to be challenging to bond.

Vacuum chamber fabrication and test. To understand how the PE material will function in an assembled system, a 6-in diameter pipe test article approximately 42-in long was designed, fabricated, and tested. The goals of this device were: 1) to demonstrate the capability of PE material to hold vacuum, and 2) to demonstrate that joints made using standard techniques can hold vacuum, even after thermal cycling.

Fabrication of the test chamber utilized techniques previously discussed: electrofusion and adhesive bonding. The electrofusion joints were made first. During the electrofusion process it was obvious that the heat produced at the joint would not affect other areas. The surface of the electrofusion collar was the warmest location and while it was warm to the touch, it could be handled easily without gloves or other protection. The electrofusion process was performed as known in the art. This joint was chosen to prevent peel failure during cooldown and because it provides the best performance high-pressure joint available for plastic pipe. Because the PE has a low thermal conductivity of ˜0.1 W/m-K, all joints must be cooled down in a controlled fashion since the joint will have high temperature gradients that will add to the nominal stress.

The vacuum port was installed on the end of the vacuum chamber using an adhesive joint. After electrofusion, the pipe was machined to put a large, tapped hole in one end. An ISO-KF 50 vacuum flange was made to match the chamber. Both the aluminum flange and the end of the PE chamber were chemically etched and bonded using EPON 828 epoxy with Versamid 125 hardener.

To ensure the integrity of the chamber, a leak test was performed using a helium leak detector capable of measuring leaks down to 1×10-9 sccs. No leaks were found. This test showed that vacuum-tight joints can be produced with PE, either using adhesive bonding or electrofusion, a very significant finding.

Vacuum integrity test. To acquire vacuum within the PE vacuum chamber, it was connected to a turbomolecular pump backed by a dry diaphragm pump. Upstream of the turbo pump was a LN2 cold trap that increased the pumping capacity of the system and trapped the high initial gas load from the plastic, ˜0.1% by weight, allowing the turbo pump to remove these contaminants during a standard elevated temperature bakeout. Also included in the system were vacuum gages and valves to measure the vacuum and the vacuum decay rate when the chamber was isolated from the pump. The chamber was wrapped with heating cables and fiberglass insulation in order to bake out the PE at elevated temperatures to accelerate vacuum acquisition.

The parameters of interest in the vacuum acquisition process were: 1) the lowest vacuum pressure achievable during active pumping, and 2) the rate at which the vacuum decays to ambient when isolated from the pump. The vacuum decay rate was measured with the chamber at room temperature and while one end was immersed in LN2.

The vacuum acquisition process reached vacuum pressures of less than 1 mtorr within the first 30 minutes of pumping. Within one day of pumping, the vacuum pressures achieved during active pumping were below the lower limit of the vacuum gages used, 5×10-5 torr.

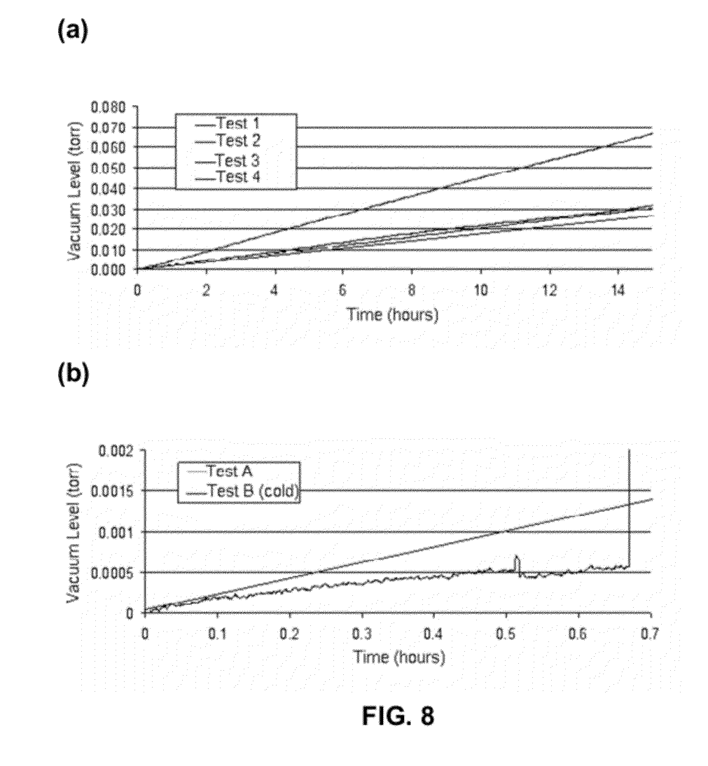

The vacuum decay results are shown in FIG. 8. The vacuum decay improved for each measurement, and the decay rate improved by over a factor of two when a portion of the chamber was cooled with LN2. The measured vacuum decay rate also includes many external joints in the vacuum piping system, so the test measurements will show higher decay rates than would be expected for the vacuum chamber alone. Permeation through the PE material is also expected to contribute to the total gas load.

The decay rate when the chamber is cold is an important parameter because it represents the decay rate expected when the cryostat is in use with LN2 flowing through the inner pipe. When molecules come in contact with the cold surface of the inner pipe, they will freeze and stick to the surface. Therefore, the vacuum level should quickly become constant when the inner line reaches LN2 temperature. These plastic materials do not contain helium or hydrogen contamination common to metals, so a standard getter should remove all residual gas species.

One must maintain the tensile strain below the design limit during cooldown of plastics. This may be accomplished through careful design, use of compression joints and possibly the addition of high thermal conductivity (metallic) shunts to maintain good temperature uniformity and reduced temperature gradients in the structure. This is because the highest thermal conductivity material in a plastic cryogenic system is typically the cryogen and large thermal gradients can develop rapidly and take a long time to dissipate unlike metallic cryogenic systems.

Integrity of the cryostat can be maintained by steps including:
Cooling down at a rate not to exceed ˜2 K/minute during the first hour, utilizing the large elongation-to-break characteristics to minimize the stress and then follow with immersion in the LN2. Faster cooldowns may be performed once a properly designed joint is implemented.
Cooling from the inside as intended in the final design may have eliminated the compressive failure. Tensile failure must still be considered.
Stress annealing of the final object may have reduced internal stresses and prevented failure.

A redesigned coupling may be thinner and contain metallic sections to assure good longitudinal heat transfer in the final product to reduce the thermal gradients during cooldown.

### 2-D Thermal Analysis

A 2-D thermal analysis was performed and reflected the increased length of the conical metal transition component connecting the outer plastic pipe to the cold inner line. The assumptions made in this analysis were:
Inner pipe temperature fixed at 77K
Outer plastic pipe and coupling surfaces fixed at 293K
Metal transition component thickness −0.040 in
   Heat transfer path along metal transition component=20 in (includes 8-in length between end of conical section and beginning of metal/plastic bond length)
   Bond length between components=10 cm
   Outer plastic pipe material and thickness: DGDA 2420, 0.5 in
   Outer plastic pipe length=1 m

The thermal model predicts that the maximum temperature difference is 15.6 K. The increase in heat transfer path length helped to decrease the ΔT value. This was partially offset by the increased heat transfer path cross-sectional area in the new, larger conical transition part. Less thermal gradient results in less joint stress.

### Component-Level Testing

A model was generated to study the effect of permeation on vacuum retention. The first condition simulated was that of the article described above. The predicted vacuum loss, based on the dimensions and material used, was 1.8 mtorr/hour, while the measured vacuum loss was 2.0 mtorr/hour. Material data for the permeability coefficients of various materials are quite scarce, so such close agreement was very positive, and also indicated that permeability was primary cause of vacuum degradation. Using the mathematical model to predict the performance of pipes incorporating a barrier layer indicated that improvements of 100 times were possible using various barrier materials.

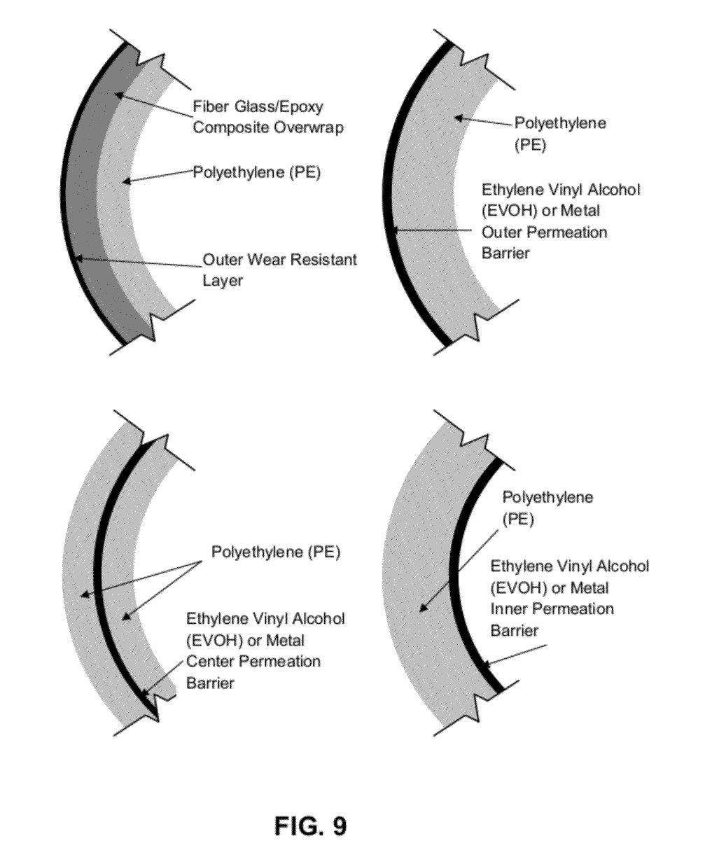

Three polymer-based barrier materials were identified and pipe samples were obtained to test their effectiveness. These sample pipes each have their own unique configuration of barrier materials integrated with the HDPE or PE materials and are shown in FIG. 9.

### Pipe Bond Joints

Bond tests were designed and performed to investigate the effectiveness of various adhesives and techniques in the formation of the PE to metal joints. Two adhesives were tested:1) a standard, low-outgassing aerospace adhesive (Hysol EA9392), and 2) an adhesive designed specifically for PE bonding (Loctite 3034). The Hysol adhesive is common in aerospace applications, has high strength and low outgassing, and is expected to form vacuum quality joints without significant risk. Disadvantages of this adhesive are that the cure time is rather long and that it requires the PE surfaces to be treated prior to bonding. The Loctite 3034 was developed specifically for bonding to PE materials. The low surface energy of PE results in low bond strength unless the surfaces have been treated. Use of the Loctite adhesive would have great advantages in a production environment because no surface treatment would be necessary, and also because the cure time is relatively short. The outgassing performance of the Loctite adhesive has not been tested to date. Bond tests showed that the Hysol adhesive performed as expected. Loctite 3034, unfortunately, performed rather poorly. These bonds generally had poor quality and would not be acceptable for vacuum service. Additionally, the strength of these bonds was roughly 50% of the expected value. Although other PE-specific adhesives will likely be evaluated in the future to streamline the manufacturing process, the current bond design is to use adhesive #1 with a treated PE surfaces.

Vacuum test articles were assembled using the three pipe designs. The ends of each pipe were closed off with metal fittings. Ports for pumpout and vacuum measurement were added, and an internal pipe for liquid nitrogen (LN2) was included in the metal fittings. The fittings were bonded to the PE pipes using the Hysol 9392 adhesive. The low surface energy of PE results in low bond strength, so the PE surfaces were plasma etched prior to bonding.

All three pipe samples underwent vacuum acquisition, conditioning and vacuum retention testing.

The vacuum decay rate predicted using the model was 1.5 mtorr/hour. The decay rate measured was 1.8 mtorr/hour, a difference of 17%. Known limitations of the model are that it only predicts vacuum decay due to gas permeation. The contributions from outgassing and leaks were not addressed. Also, the permeability coefficients for PE demonstrated a strong dependence on the density of the PE, and resin type was not addressed, leaving open the possibility that process and resin variations may affect these coefficients.

Commercially-available pipes for the vacuum jacket of the cryostat were researched to evaluate the performance of alternative materials. Additionally, example coatings were researched to reduce the vacuum gas load due to permeation.

The result is two approaches that include metallic layers or polymer coatings with up to 1/10,000th of the permeability of uncoated polyethylene. Additionally, combinations of materials are used to provide optimal permeation resistance. One effective means of limiting gas molecules from permeating through the vacuum jacket is to include a permeation layer, which can be a metal liner for example, aluminum in an embodiment, with the plastic pipe. Examples of permeation barriers are aluminum, stainless steel and titanium, in separate embodiments. This aspect of the invention can be performed in multiple ways, as is known to one of ordinary skill in the art, including by placing a metal liner between layers of plastic, so that both the inner and outer surfaces of the pipe are plastic, or by placing the metal layer at the inner or outer surface of the pipe where it is exposed to the environment. The former method is more common because the metal liner is protected on both sides by plastic, which is effective in preventing corrosion. Various manufacturers produce this type of multilayer pipe, generally designated as PE/AL/PE for example to indicate the layer materials. In the example above, the pipe layers are polyethylene (PE), aluminum (Al), and polyethylene (PE).

Other common permeation barriers are polymeric, as certain polymers are exceptionally effective in limiting gas flow. This is particularly useful for the food packaging industry. Polymeric permeation barriers, like the metallic barriers previously discussed, can be placed on the outer surface of the pipe, the inner surface, or as a protected internal layer of the pipe.

Various polymers have been used extensively as permeation barriers. Ethylene vinyl alcohol (EVOH) is one of the most common materials due to its high permeation resistance. The Kuraray Company has developed a family of EVOH resins, known as EVAL, with even greater permeation resistance. Golan produces PE and PEX pipes in very large diameters, coated on their OD surfaces with EVOH. Tehmco also produces large PE barrier pipe, but their EVAL coatings are placed as in internal layer within the pipe. All of these commercially available materials can be used in the systems and methods of the current invention. The pipes can be preformed or formed in the desired diameter and length by methods known in the art.

Another type of barrier pipe, made by Fiberspar, does not use traditional barrier materials. The pipe is made of PE with a fiberglass/epoxy composite overwrap. This combination of materials results in much higher permeation resistance than might be expected. Permeability testing has been performed on this type of pipe construction.

Should permeation be too high with the fiberglass/epoxy over wrap construction, one aspect of the current disclosure includes the combination of fiberglass/epoxy over wrap construction with the EVOH or metallic barriers described above.

### Bonding Joints

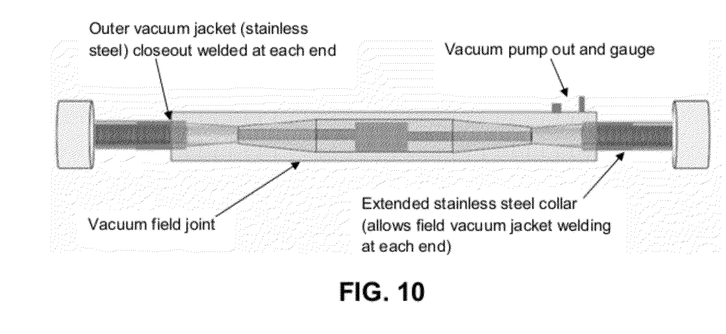

Two types of cryostat end terminations are: 1) field joint, and 2) bayonet connections. The field joint concept is shown in FIG. 10 involving a welded inner-pipe connection and a stand-alone vacuum section to insulate the completed joint. Alternately, a standard bayonet can be substituted for the field joint shown to provide the required interface with a termination station. Both these termination types can be used with the methods of the current disclosure.

There are several elements to the joint design of a HTS cable cryostat using PE as the primary material. Vacuum-tight joints must be made using joining techniques not used in traditional metal vacuum vessel construction. Additionally, the joints have to withstand thermal cycling and stress associated with thermal contraction, pressure loading, and cable bending. These concerns require methods of joining including adhesive bonding, thermal fusion, and electrofusion.

These aspects are described elsewhere herein.

### Assembly Process

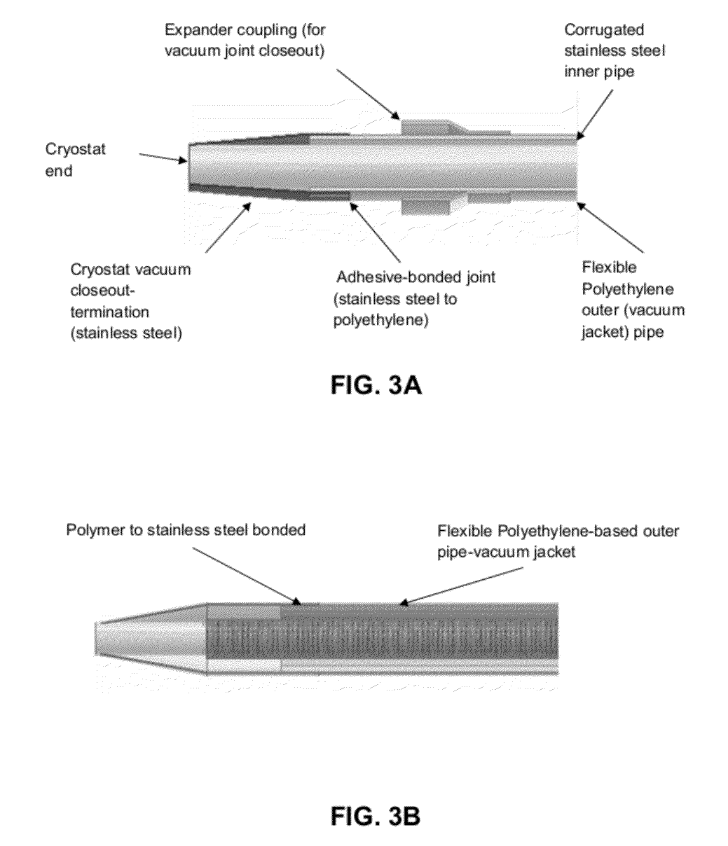

The unique joint associated with the flexible cryostat design described here is the polymer to stainless steel bonded transition shown in FIG. 3B. Due to its low surface energy, PE is inherently difficult to form an effective bond with. Various treatments exist that can be used to increase the surface energy of PE, and thereby improve bond strength, including chemical etching using chromic acid or sulfuric acid, or plasma treatment. The stainless steel surface is also prepared by conventional methods for adhesive bonding. In addition to meeting bond strength requirements, the adhesive used must be low outgassing to be suitable for a vacuum joint. Both surface treatment methods have been demonstrated with a low outgassing epoxy.

Useful epoxies include Epon 828/Versamide 125 and Hysol 9392. An additional benefit of the Hysol 9392 is that it has a 177° C. service temperature, enabling higher vacuum bakeout temperatures following cryostat assembly. Higher bakeout temperatures improve manufacturing efficiency by reducing the time required for active vacuum pumping. One of ordinary skill in the art will be able to use these techniques using the current materials without undue experimentation using the description provided herein.

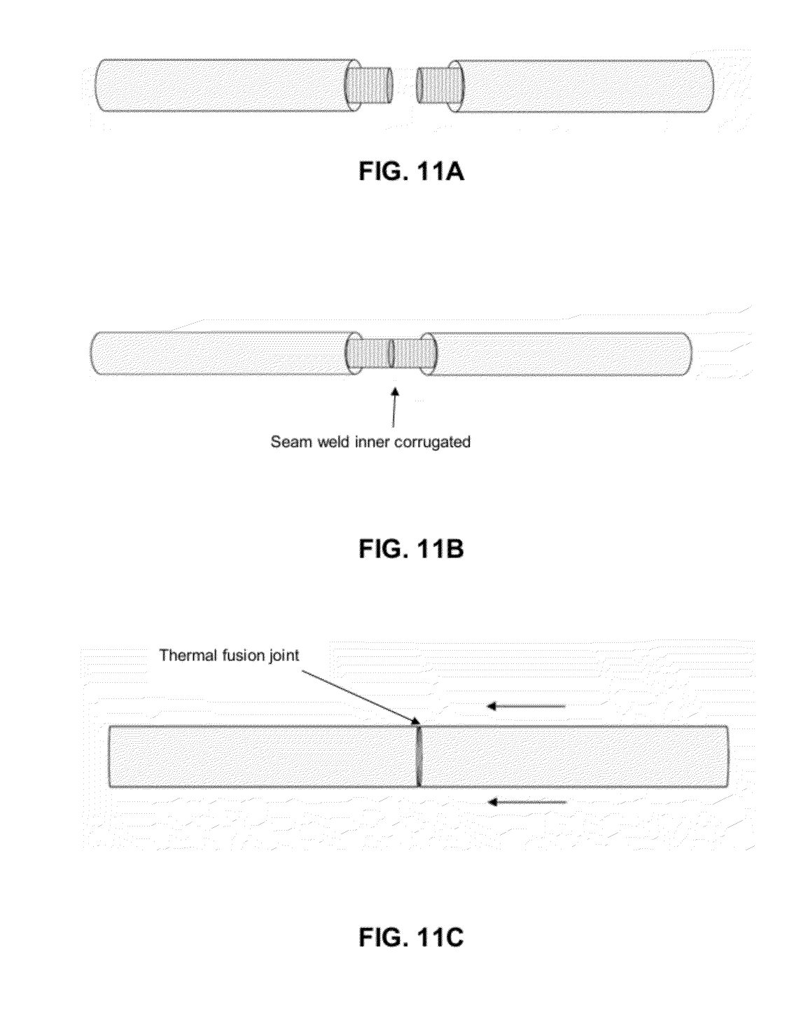

Outgassing of the polyethylene-based pipe is also reduced through the bakeout process. One polyethylene pipe used for the exemplary cryostat system described here has a service temperature of at least 90° C. Cryostat assembly will take place using methods typically used for current flexible vacuum jacketed cryostats with the exception of processes unique to the use of a polyethylene-based vacuum jacket. One approach is to fabricate the cryostat in sections in lengths that are dictated by the manufacturing facility and available lengths of the inner and outer pipe materials. This will require each section to be connected such that finished cryostats of up to 500-m lengths can be fabricated. The assembly sequence is illustrated in FIGS. 11A-11E. With the completed cryostat sections positioned for final joining, the inner corrugated stainless steel pipe is seam welded to form the finished inner pipe that will contain the superconducting cable and liquid nitrogen refrigerant as shown in FIG. 11B. Next, multilayer insulation (MLI) will be applied to this joint, as was previously used for the completed cryostat section to form a continuously insulated inner pipe. MLI is the preferred insulation for use in vacuum level below 10⁻³ torr. Other insulation types such as aerogel, microspheres, or foams could be considered for applications that do not require a high level of thermal performance.

Based on the gas load from permeation and expected outgassing of the cryostat materials, a suitable getter system can be installed into the vacuum space to provide the required vacuum performance for the life of the cryostat. With the inner pipe joined and insulated, the outer pipe section being added to the cryostat assembly is slid over the completed inner pipe and insulation subassembly to form the final joint of the outer pipe vacuum barrier for the cryostat. One method is to join the polyethylene-based pipe by thermal fusion butt joint as is commonly practiced for joining this type of pipe in municipal water or natural gas applications as shown in FIG. 11C. Following completion of each pipe section joint, the cryostat is coiled until the desired cryostat length is achieved as shown in FIG. 11D. Vacuum pump down will be performed as illustrated in FIG. 11E while applying heat as part of a bakeout process to accelerate the outgassing and removal of adsorbed contaminants such as moisture. This process is essentially the same process used for current vacuum-jacketed pipe manufacturing.

### Example

An exemplary cryostat design was prepared by adding a stainless steel section that facilitates attaching this cryostat section in the field. This field-joint section, approximately 10 inches long, was bonded to the outside of the treated plastic outer pipe on one end and welded to the large-diameter mouth of the steel inner/outer transition that connects the inner and outer transition piece at the other end. As an example, the Hysol EA939 adhesive was used. This adhesive requires the PE surfaces to be treated prior to bonding, with plasma etching the polyethylene and then bonding to the treated or prepared surface, for example. These aspects are described elsewhere herein.

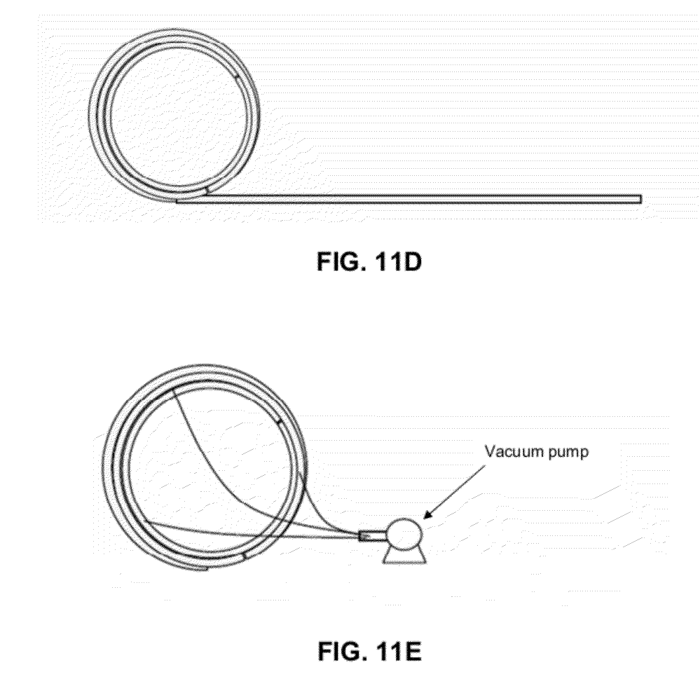

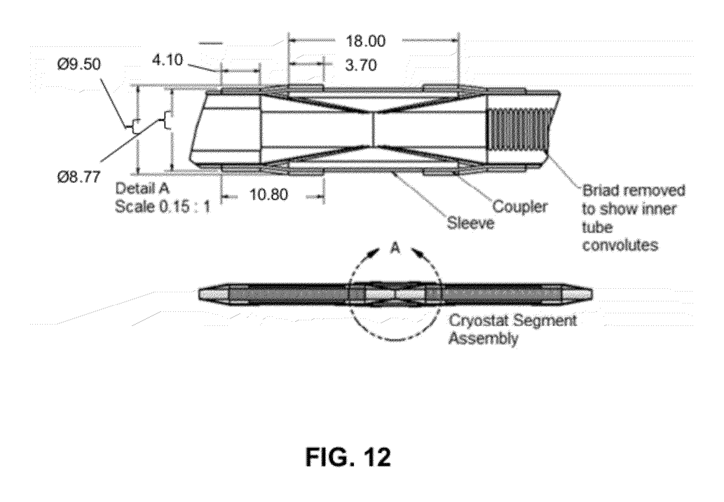

The remaining eight inches of length serves as thermal isolation and a heat sink between the welded surfaces and the steel-to-plastic bond during welding. This section will usually already be in place at the time of installation. This exemplary design is shown in FIGS. 12, 13 and 3A.

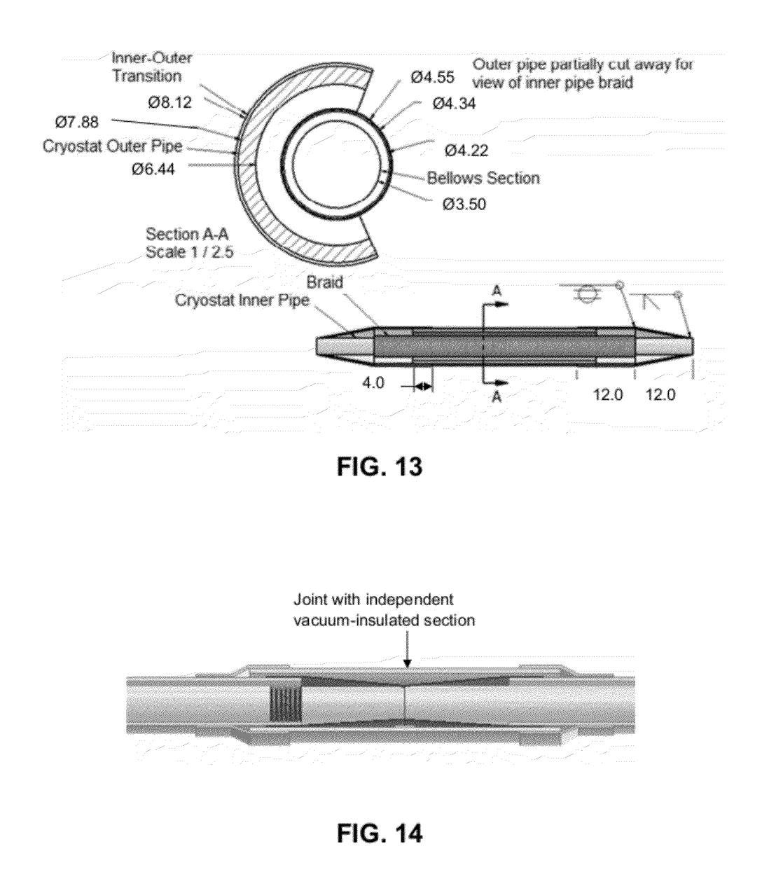

FIG. 14 illustrates the concept for a completed cryostat section joint that is installed in the field.

This joint typically has an independent vacuum space with multilayer insulation as is typically used in field joints for vacuum-jacketed pipe.

### REFERENCES

WO2010/095925; U.S. Pat. No. 4,215,798; WO02/095925; EP 02144258; U.S. Pat. No. 6,883,549; U.S. Pat. No. 3,431,347; WO 06/111170; US 2008/179070; EP 0297061; U.S. Pat. No. 4,462,214; EP 1363062; EP 01195777; U.S. Pat. No. 7,009,104; US 2010/0227764.

### Incorporation by Reference

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a pipe composition is claimed, it should be understood that pipe compositions known in the prior art, including certain pipe compositions disclosed in the references disclosed herein (particularly in referenced patent documents), are not intended to be included in the claim.

When a group of substituents is disclosed herein, it is understood that all individual members of those groups and all subgroups, including any isomers and enantiomers of the group members, and classes of compounds that can be formed using the substituents are disclosed separately. When a compound or material is claimed, it should be understood that compounds known in the art including the compounds or materials disclosed in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, materials and dimensions other than those specifically exemplified can be employed in the practice of the invention without resort to undue experimentation. All art-known functional equivalents, of any such methods, device elements, materials and dimensions are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The definitions are provided to clarify their specific use in the context of the invention.

All patents and publications mentioned in the specification are indicative of the levels of skill of those skilled in the art to which the invention pertains. One skilled in the art readily appreciates that the present invention is well adapted to carry out the objects and obtain the ends and advantages mentioned, as well as those inherent in the present invention. The methods, components, materials and dimensions described herein as currently representative of preferred embodiments are provided as examples and are not intended as limitations on the scope of the invention. Changes therein and other uses which are encompassed within the spirit of the invention will occur to those skilled in the art, are included within the scope of the claims.

Although the description herein contains certain specific information and examples, these should not be construed as limiting the scope of the invention, but as merely providing illustrations of some of the embodiments of the invention. Thus, additional embodiments are within the scope of the invention and within the following claims.

We claim:

1. A cryostat comprising:
an inner pipe and an outer pipe, wherein the inner pipe is oriented inside the outer pipe in a generally concentric arrangement;
an annular region between said pipes for supporting vacuum conditions;
wherein the outer pipe comprises a polyethylene and a permeation barrier, and wherein the annular region comprises an insulation material.

2. The cryostat of claim 1, wherein the inner pipe comprises a polyethylene.

3. The cryostat of claim 1, wherein the inner pipe comprises stainless steel.

4. The cryostat of claim 1 or 2, wherein the polyethylene is selected from the group consisting of: high density polyethylene, medium density polyethylene, low density polyethylene and crosslinked polyethylene (PEX).

5. The cryostat of claim 1, wherein the insulation material is selected from the group consisting of: MLI, aerogel, microspheres or foam.

6. The cryostat of claim 2, wherein the inner pipe further comprises a permeation barrier.

7. The cryostat of claim 1 or 6, wherein a permeation barrier is ethylene vinyl alcohol.

8. The cryostat of claim 1 or 6 wherein a permeation barrier is a metal.

9. The cryostat of claim 8, wherein the metal is selected from the group consisting of:
aluminum, stainless steel, or titanium.

10. The cryostat of claim 1 or 6, wherein a permeation barrier is fiberglass.

11. The cryostat of claim 1, wherein a permeation barrier is adjacent to the inner surface of the outer pipe.

12. The cryostat of claim 1, wherein the permeation barrier is continuous and is surrounded by the outer pipe on both sides.

13. The cryostat of claim 1, wherein a permeation barrier is adjacent to the outer surface of the outer pipe.

14. The cryostat of claim 6, wherein a permeation barrier is adjacent to the inner surface of the inner pipe.

15. The cryostat of claim 6, wherein the permeation barrier is continuous and is surrounded by the inner pipe on both sides.

16. The cryostat of claim 6, wherein a permeation barrier is adjacent to the outer surface of the inner pipe.

17. The cryostat of claim 1, wherein the outer pipe permeation barrier is independently one or more of claims 11-16.

18. The cryostat of claim 6, wherein the inner pipe permeation barrier is independently one or more of claims 11-16.

19. A method of joining two sections of cryostat together, where each cryostat section comprises an inner stainless steel pipe and an outer polyethylene pipe, with an annular space therebetween the method comprising:
Welding the inner stainless steel pipe joints together;
Adding an optional insulation material in the annular space;
Joining by preparing the polyethylene surface with plasma etching or acid etching and bonding the outer polyethylene pipes together.

20. The method of claim 19, wherein the insulation material is MLI, aerogels, microspheres or foam.

21. The method of claim 19, wherein the joining is one or more of welding, adhesive bonding, thermal fusion, or electrofusion.

22. A method of joining two sections of cryostat together where the first cryostat section comprises an inner stainless steel pipe and an outer stainless steel pipe with an annular space therebetween and the second cryostat section comprises an inner stainless steel pipe and an outer polyethylene pipe, the method comprising:
Joining the inner stainless steel pipe of the first cryostat section with the inner stainless steel pipe of the second cryostat section by welding;
Joining the outer stainless steel pipe of the first cryostat section with the outer polyethylene pipe of the second cryostat section by preparing the polyethylene surface with plasma etching or acid etching and bonding the pipes together.

23. The method of claim 22, wherein the joining is one or more of welding, adhesive bonding, thermal fusion, or electrofusion.
